(19) United States
(12) Patent Application Publication
(10) Pub. No.: US 2025/0220445 A1
(43) Pub. Date: Jul. 3, 2025

(54) COMMUNICATION NETWORK FIBER OPTIC DATA SERVICE EXPANSION

(71) Applicant: AT&T Intellectual Property I, L.P., Atlanta, GA (US)

(72) Inventors: Vahid Tavassoli, Alpharetta, GA (US); Allison Whittaker, Alpharetta, GA (US)

(21) Appl. No.: 18/398,122

(22) Filed: Dec. 27, 2023

(51) Int. Cl. H04W 16/18; H04L 41/50

(52) U.S. Cl. CPC H04W 16/18; H04L 41/5077

(57) ABSTRACT

A processing system may obtain network inventory data, development infrastructure information, and user information to train a prediction model to predict precedence metrics for a new fiber optic data service in geographic areas that do not include a current fiber optic data service of the communication network, the prediction model comprising at least one machine learning model. The processing system may then generate a precedence metric of a geographic area that does not include the current fiber optic data service by applying to the prediction model: current network inventory data, current development infrastructure information, and current user information, where an output of the prediction model comprises the at least one precedence metric. In addition, the processing system may perform a network reconfiguration action in the communication network in response to the at least one precedence metric of the geographic area.

The present disclosure relates to communication network operations, and more particularly to methods, computer-readable media, and apparatuses for performing at least one network reconfiguration action in a communication network in accordance with a precedence metric for a new fiber optic data service for a geographic area that is generated via a prediction model based upon current network inventory data, development infrastructure information, and user information.

### BACKGROUND

Deploying, upgrading, and extending communication networks are expensive operations. There are high costs involved in the design and planning of networks, purchase of network elements, installation of elements like antennas, fibers, wireless connections, routers, switches and other network functions. The maintenance and operations of the network incur high costs as well, including costs like power, cooling, taxes, fees, etc. Thus, network planning decision may be based not just on the cost of the equipment and the installation, but also on the potential earning from each item.

### SUMMARY

In one example, the present disclosure provides a method, non-transitory computer-readable medium, and apparatus for performing at least one network reconfiguration action in a communication network in accordance with a precedence metric for a new fiber optic data service for a geographic area that is generated via a prediction model based upon current network inventory data, development infrastructure information, and user information. For example, a processing system including at least one processor deployed in a communication network may obtain network inventory data of the communication network, wherein the network inventory data is associated with a plurality of geographic areas, obtain development infrastructure information associated with the plurality of geographic areas, and obtain user information associated with users in the plurality of geographic areas. The processing system may next train a prediction model to predict precedence metrics of a new fiber optic data service of the communication network in geographic areas of the plurality of geographic areas that do not include a current fiber optic data service of the communication network, where the prediction model comprises at least one machine learning model. The processing system may then generate at least one precedence metric of at least one of the plurality of geographic areas that does not include the current fiber optic data service, by applying to the prediction model: current network inventory data of the communication network associated with the plurality of geographic areas, current development infrastructure information associated with the plurality of geographic areas, and current user information associated with users in the plurality of geographic areas, where an output of the prediction model comprises the at least one precedence metric. In addition, the processing system may then perform at least one network reconfiguration action in the communication network in response to the at least one precedence metric of the at least one of the plurality of geographic areas that does not include the current fiber optic data service.

### BRIEF DESCRIPTION OF THE DRAWINGS

The present disclosure can be readily understood by considering the following detailed description in conjunction with the accompanying drawings, in which:

FIG. 1 illustrates one example of a system including a telecommunication network, according to the present disclosure;

FIG. 2 illustrates an example artificial intelligence (AI)/machine learning (ML) platform for providing predictions/prioritizations for new fiber optic data services in various geographic areas, in accordance with the present disclosure;

FIG. 3 illustrates a flowchart of an example method for performing at least one network reconfiguration action in a communication network in accordance with a precedence metric for a new fiber optic data service for a geographic area that is generated via a prediction model based upon current network inventory data, development infrastructure information, and user information; and

FIG. 4 illustrates a high level block diagram of a computing device specifically programmed to perform the steps, functions, blocks and/or operations described herein.

To facilitate understanding, identical reference numerals have been used, where possible, to designate identical elements that are common to the figures.

### DETAILED DESCRIPTION

The present disclosure broadly discloses methods, non-transitory (i.e., tangible or physical) computer-readable media, and apparatuses for performing at least one network reconfiguration action in a communication network in accordance with a precedence metric for a new fiber optic data service for a geographic area that is generated via a prediction model based upon current network inventory data, development infrastructure information, and user information. For instance, examples of the present disclosure may regularly collect and store data from different sources on both fiber optic deployment and cellular infrastructure expansion projects (e.g., in accordance with 5G or future developed technologies, and including new builds as well as addition of higher speed technologies to existing installations) and their completion stages. Examples of the present disclosure may further collect data on development infrastructure (e.g., existing buildings, as well as ongoing construction), data pertaining to existing users, population density, and demographics, and any information related to prospective fiber optic and/or fixed wireless broadband (FBW) users in various geographic areas. In one example, the present disclosure may structure the data for use in targeting the discovery of prospective user locations for fiber/5G FWB technologies with fastest delivery time and minimized cost. In particular, in one example, the present disclosure may train and implement an artificial intelligence (AI)/machine learning (ML) platform/model using the structured data to provide predictions/prioritizations for new fiber optic data services in various geographic areas. In one example, the AI/ML platform may include one or more machine learning models (MLMs), which may be trained to predict/forecast the expenses, required time to deliver fiber/5G FWB access to a geographic area, the predicted number of users to served (and/or the types of users to be served (e.g., consumer, business, governmental, etc.)), the predicted additional revenue from such deployments, and so forth. In one example, an Al layer may implement one or more rules in accordance with such forecasts to prioritize different geographic areas for new fiber optic data services. It should be noted that in one example, the present disclosure may further incorporate manual inputs from trusted sources (e.g., network personnel, one or more other automated systems of the communication network, etc.) pertaining to geographic areas for new fiber optic data services.

When a communication network is expanding fiber optic broadband services, including multi-gigabit services, for both in-region (e.g., brownfield) and out-of-the-region (e.g., greenfield) areas and for single family units (SFUs) and other residential and business complexes, additional users may be increasingly interested in the offered services and may request connection to the fiber optic data network. A similar demand may exist in remote areas, which may be served by fixed wireless broadband (FWB), e.g., a fiber-optic/5G hybrid service where cellular service are used for the “last-mile.” However, multifaceted complexity and significant investment cost of fiber deployment as well as for 5G radio access networks (RAN) may prevent or hinder expansion of the fiber optics network and/or the extending of radio network range. On the other hand, existing and prospective users of the communication network that do not have access to fiber optic data services may complain about the lack of fiber-availability, particularly where nearby areas may already have such access.

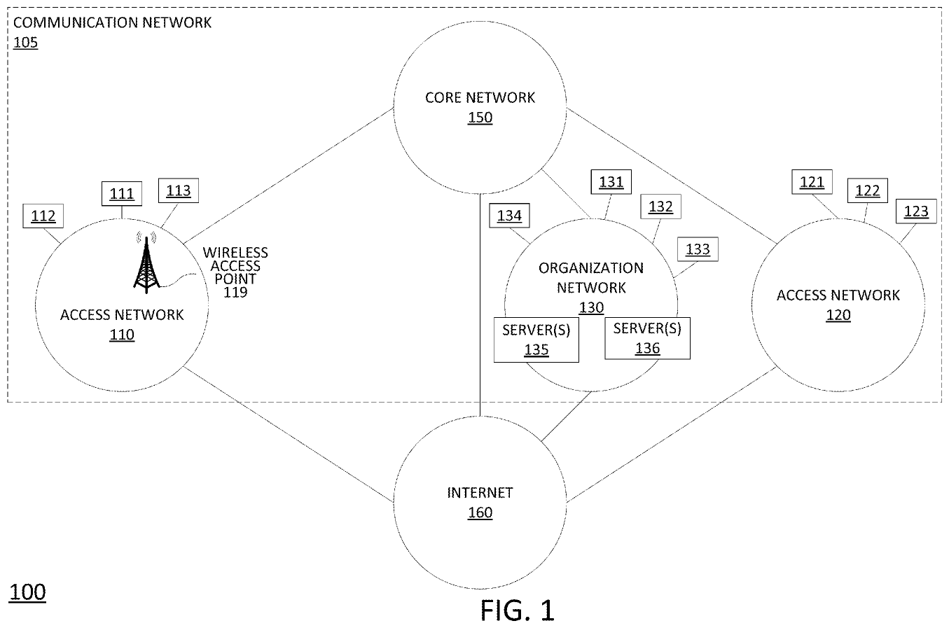

Examples of the present disclosure collect and analyze such fiber optic data service deployments and prospective deployments at different locations on an ongoing basis. For instance, examples of the present disclosure may use geographic and technological data, as well as manually entered requests and data by trusted parties (e.g., network personnel, existing users/subscribers, etc.) via an AI/ML platform to generate an accurate design for fiber optic data service network deployment to provide capacity where it is most effective, resulting in optimized resource utilization with minimized wastage of excess capacity, reduced energy usage, economic efficiency, faster time to decision, and other benefits. In addition, a communication network, and more specifically an Internet service provider (ISP), may employ access network connectivity technology such as fiber broadband, 5G wireless, or hybrid approaches such as FWB (or fixed wireless access (FWA)/broadband wireless access (BWA)). Examples of the present disclosure may consistently and reliably determine the best next expansion project with the most suitable access technology. In one example, the present disclosure may provide a report comprising the top candidate geographic areas for new fiber optic data services to be deployed (e.g., including new fiber deployment) based on the latest information on the status of network expansion projects as well as data on user demographics and demand, neighborhood and business construction/development, and so forth. These and other aspects of the present disclosure are discussed in greater detail below in connection with the examples of FIGS. 1-4.

To aid in understanding the present disclosure, FIG. 1 illustrates an example system 100 comprising a plurality of different networks for supporting the generating of construction zones based upon a link-weighted adjacency graph of distribution areas of a telecommunication network, in accordance with the present disclosure. Communication network 105 may comprise a core network 150 with components for telephone services, Internet services, and/or television services (e.g., triple-play services, etc.) that are provided to customers (broadly “subscribers”), and to peer networks. In one example, core network 150 may combine core network components of a cellular network with components of a triple-play service network. For example, core network 150 may functionally comprise a fixed mobile convergence (FMC) network, e.g., an IP Multimedia Subsystem (IMS) network. In addition, core network 150 may functionally comprise a telephony network, e.g., an Internet Protocol/Multi-Protocol Label Switching (IP/MPLS) backbone network utilizing Session Initiation Protocol (SIP) for circuit-switched and Voice over Internet Protocol (VOIP) telephony services. Core network 150 may also further comprise a broadcast television network, e.g., a traditional cable provider network or an Internet Protocol Television (IPTV) network, as well as an Internet Service Provider (ISP) network. With respect to television service provider functions, core network 150 may include one or more television servers for the delivery of television content, e.g., a broadcast server, a cable head-end, a video-on-demand (VOD) server, and so forth. For example, core network 150 may comprise a video super hub office, a video hub office and/or a service office/central office. For ease of illustration, various components of core network 150 are omitted from FIG. 1.

In one example, access networks 110 and 120 may each comprise a Digital Subscriber Line (DSL) network, a fiber optic access network, a broadband cable access network, a Local Area Network (LAN), a cellular or non-cellular wireless access network, and the like. For example, access networks 110 and 120 may transmit and receive communications between endpoint devices 111-113, endpoint devices 121-123, and service network 130, and between core/backbone network 150 and endpoint devices 111-113 and 121-123 relating to voice telephone calls, communications with web servers via the Internet 160, and so forth. Access networks 110 and 120 may also transmit and receive communications between endpoint devices 111-113, 121-123 and other networks and devices via Internet 160. In another example, one or both of the access networks 110 and 120 may comprise an ISP network external to communication network 105, such that endpoint devices 111-113 and/or 121-123 may communicate over the Internet 160, without involvement of the communication network 105. Endpoint devices 111-113 and 121-123 may each comprise customer premises equipment (CPE), user equipment (UE), and/or other endpoint device types, such as a telephone, e.g., for analog or digital telephony, a mobile device, such as a cellular smart phone, a laptop, a tablet computer, etc., a router (e.g., a customer edge (CE) router), a gateway, a desktop computer, a plurality or cluster of such devices, a television (TV), e.g., a “smart” TV, a set-top box (STB), and the like. In some examples, endpoint devices 111-113 and 121-123 may connect to access networks 110 and 120 via one or more intermediate devices, such as a gateway and router, an Internet Protocol private branch exchange (IPPBX), and so forth.

In one example, the access networks 110 and 120 may be different types of access networks. In another example, the access networks 110 and 120 may be the same type of access network. In one example, one or more of the access networks 110 and 120 may be operated by the same or a different service provider from a service provider operating the core network 150. For example, each of the access networks 110 and 120 may comprise an Internet service provider (ISP) network, a cable access network, and so forth. However, in an example, in which access network(s) 110 and/or 120 are part of communication network 105, then the communication network 105 may also be considered to be an ISP network. In another example, each of the access networks 110 and 120 may comprise a cellular access network, implementing such technologies as: global system for mobile communication (GSM), e.g., a base station subsystem (BSS), GSM enhanced data rates for global evolution (EDGE) radio access network (GERAN), or a UMTS terrestrial radio access network (UTRAN) network, among others, where core/backbone network 150 may provide cellular core network functions, e.g., of a public land mobile network (PLMN)-universal mobile telecommunications system (UMTS)/General Packet Radio Service (GPRS) core network, or the like. For instance, access network(s) 110 may include at least one wireless access point (AP) 119, e.g., a cellular base station, such as an eNodeB, or gNB, a non-cellular wireless access point (AP), such as an Institute of Electrical and Electronics Engineers (IEEE) 802.11 (Wi-Fi) access point, or the like.

In one example, access networks 110 and 120 may include a plurality of distribution areas (DAs). The distribution areas may include portions of access networks 110 and 120 associated with individual nodes (e.g., fiber optic nodes and/or digital subscriber line access multiplexers (DSLAMs)) and may serve multiple living units (LUs). The living units may include single family homes and businesses, as well as multi-dwelling units (MDUs). The distribution areas may be further associated with different wire centers and/or central offices (COs) (CLLI8) of the communication network 105 and/or access networks 110 and 120. Each distribution area may be a portion of the communication network 105 with fiber to the node (FTTN) or fiber to the curb (FTTC) already deployed (e.g., a hybrid fiber-coaxial (HFC) access network portion), or may comprise regions of the communication network 105 with electrically wired trunks/routes from central offices to nodes (e.g., a DSL access network portion, etc.). In addition, distribution areas may be associated with either overhead utility wiring (aerial) or buried utility wiring (buried).

In one example, an organization network 130 may comprise a local area network (LAN), or a distributed network connected through permanent virtual circuits (PVCs), virtual private networks (VPNs), and the like for providing data and voice communications. In one example, the organization network 130 links one or more endpoint devices 131-134 with each other and with Internet 160, core network 150, devices accessible via such other networks, such as endpoint devices 111-113 and 121-123, and so forth. In one example, endpoint devices 131-134 may each comprise a telephone for analog or digital telephony, a mobile device, a cellular smart phone, a laptop, a tablet computer, a desktop computer, a bank or cluster of such devices, and the like. In one example, the organization network 130 may be associated with the communication network 105. For example, the organization may comprise the communication network service provider, where endpoint devices 131-134 of the organization network 130 may comprise devices of organizational agents, such as customer service agents, marketing personnel, or other employees or representatives who are tasked with addressing customer-facing issues and/or personnel for network maintenance, network repair, construction planning, and so forth.

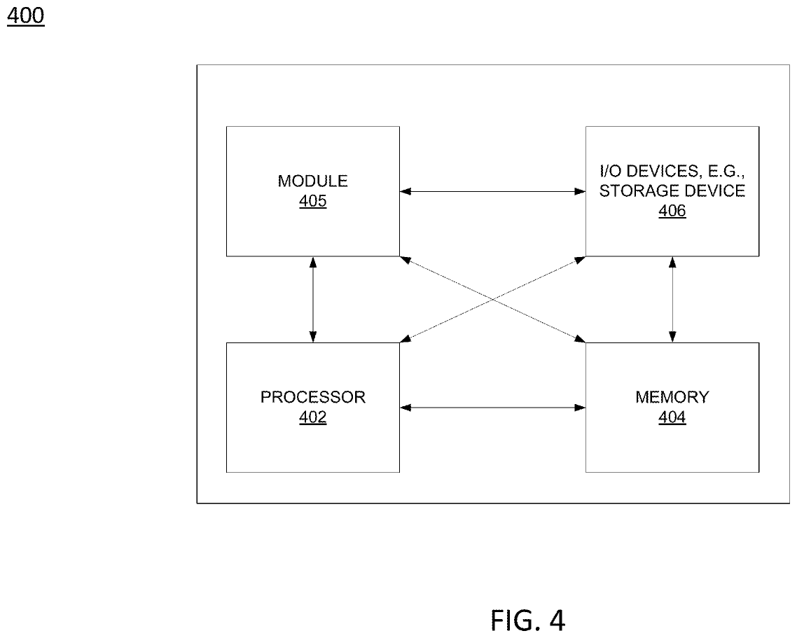

In one example, the system 100 may also include one or more servers 136 in the organization network 130. In one example, the servers 136 may each comprise a computing system, such as computing system 400 depicted in FIG. 4, and may be configured to host one or more centralized system components. It should be noted that in one example, a centralized system component may be hosted on a single server, while in another example, a centralized system component may be hosted on multiple servers, e.g., in a distributed manner. For example, a first centralized system component may comprise a database of customer/subscriber-assigned telephone numbers, while a second centralized system component may comprise a database of customer account data for all or a portion of the customers/subscribers of the communication network 105 (e.g., a unified data repository (UDR), or the like). Other centralized system components may include a billing system, a customer relationship management (CRM) system, a trouble ticket system, an inventory system (IS) (e.g., an active and available inventory (AAI) system), a provisioning system, an ordering system, an enterprise reporting system (ERS), an account object (AO) database system, and so forth.

Any one or more of such centralized system components may generate, collect and/or store user/customer information, such as demographic information comprising, for example: a number of household members, age(s), subscription plan(s), a service address, device type(s) (such as a smartphone model, a television model, a home computer model, a set top box model, a router model, and so forth), a billing history, a payment history, purchasing and ordering information, payment methods, employment information, salary information, and so forth. The user information may be based upon user interactions with the communication network 105. In one example, the user information may include inquires and/or complaints about fiber optic service. For instance, a user may enter a street address in a website to identify whether fiber optic data service is currently available for the address. Alternatively, or in addition, the user may respond to an online or automated phone questionnaire, survey, or the like, where the user may indicate dissatisfaction with the communication network 105 for the specific reason of lack of fiber optic data service availability for the user and/or the user's location. In one example, the user demographic information may also include information obtained by the communication network 105 from third parties, such as merchants, credit card companies, credit bureaus, and the like, e.g., with the user's consent.

In one example, any one or more of such centralized system components may generate, collect and/or store network inventory data of the communication network 105 (and more specifically, the access networks 110 and 120 portions thereof), e.g., existing inventory, plus current deployment projects in the works, and/or projected deployment projects. This may include data on the types of access network technology, e.g., fiber, cable, DSL, etc., the components thereof (e.g., DSLAM make, model, etc. fiber mode, fiber capacity, etc.), the utilization levels of such resources, the installation dates, the useful life, the scheduled replacement date(s) (if any), and so forth. In one example, the network inventory data may further associate network resources/inventory with respective geographic areas.

In this regard, in one example, servers 136 may include a geodatabase and query system, e.g., PostGIS, CartoDB, ArcGIS, or the like, which may store geographic information on central offices (COs), wire centers, and/or distribution areas (DAs) in portions of the communication network 105 (e.g., the access networks 110 and 120 portions thereof). In one example, one of the servers 136 may further include CLLI information regarding different network equipment with various wire centers, central offices, distribution areas, etc. and/or customer demographic information. In another example, one or more of the servers 136 may store a separate database of CLLI information and/or customer demographic information which may be joined or otherwise related to information stored by a different one of the servers 136. In one example, servers 136 may further store development infrastructure information associated with the plurality of geographic areas. For instance, this may include information regarding existing developments (e.g., building coverage/density, the type(s) of buildings, the occupancy/vacancy rates, etc.), current construction projects, and/or scheduled construction projects. In one example, such information may be obtained from one or more third party data sources, such as building department data sources, construction trade/industry data sources, etc., e.g., via one or more application programming interfaces (APIs) or the like that may expose such data to external subscribing entities. In one example, servers 136 may also include a marketing automation platform (MAP) for sending automated communications, e.g., automated phone calls, text messages, emails, and so forth, to endpoint devices 111-113 and 121-123, as well as other customer/subscriber devices, and/or for providing instructions, communication templates, or the like to marketing personnel to communicate with endpoint devices 111-113 and 121-123, as well as other customer/subscriber devices.

In one example, organization network 130 may also include an application server (AS) 135. In one example, AS 135 may comprise a computing system, such as computing system 400 depicted in FIG. 4, and may be configured to provide one or more functions for performing at least one network reconfiguration action in a communication network in accordance with a precedence metric for a new fiber optic data service for a geographic area that is generated via a prediction model based upon current network inventory data, development infrastructure information, and user information, in accordance with the present disclosure. For example, AS 135 may be configured to perform one or more steps, functions, or operations in connection with the example method 300 described below. In addition, it should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 4 and discussed below) or multiple computing devices collectively configured to perform various steps, functions, and/or operations in accordance with the present disclosure.

In one example, server(s) 135 may obtain: network inventory data associated with a plurality of geographic areas of the communication network 105 (e.g., existing inventory, plus current/ongoing deployment projects, and/or projected deployment projects), development infrastructure information associated with the plurality of geographic areas (e.g., existing development, plus current/ongoing building construction, and/or projected construction), and user information associated with users in the plurality of geographic areas (e.g., current users and/or prospective users of various types (e.g., consumer, business, governmental, etc.). For instance, any or all of such information may be obtained from server(s) 136 and/or directly from one or more data sources (e.g., without intermediate storage in server(s) 136, or the like). In one example, server(s) 135 may train a prediction model to predict precedence metrics for new fiber optic data service deployment in geographic areas that do not include a current fiber optic data service. In addition, server(s) 135 may generate at least one precedence metric of at least one of the plurality of geographic areas that does not include the current fiber optic data service. For instance, server(s) 135 may apply as inputs to the trained prediction model implemented by server(s) 135: current network inventory data of the communication network 105 associated with the plurality of geographic areas, current development infrastructure information associated with the plurality of geographic areas, and current user information associated with users in the plurality of geographic areas, where an output of the prediction model may comprise the at least one precedence metric.

Server(s) 135 may then perform at least one network reconfiguration action in the communication network 105 in response to the at least one precedence metric of the at least one of the plurality of geographic areas that does not include the current fiber optic data service. For instance, server(s) 135 may generate a list of prioritized geographic areas for new fiber optic data service deployment. In one example, the list may further include recommended deployment types in accordance with the output(s) of the prediction model, such as fiber to the premises (FTTP), fiber to the curb (FTTC), fixed wireless broadband (FWB)/fiber hybrid, leased fiber access, etc. In one example, server(s) 135 may generate a map of prioritized geographic areas for the new fiber optic service deployment. In addition, server(s) 135 may provide such a list and/or map generated in accordance with the present disclosure to personnel for network maintenance, network repair, provisioning/construction planning, and so forth, e.g., via any one or more of endpoint devices 131-134. In one example, server(s) 135 may send instructions to one of the servers 136 comprising a marketing automation platform to send automated marketing communications to one or more of endpoint devices 111-113 and 121-123, or to other devices of subscribers/customers/users associated with endpoint devices 111-113 and 121-123. For instance, in accordance with the prioritized list, server(s) 135 may identify when fiber optic data service may be made available in a geographic area, and may inform users accordingly. In one example, candidate geographic areas on the list may be tentatively identified for new fiber optic data service deployment. However, the communication network 105 may determine to further confirm interest in the geographic area by initiating one or more surveys, questionnaires, or the like regarding current user/customer and/or prospective user interest. Alternatively, or in addition, server(s) 135 may send instructions to one or more of the endpoint devices 131-134 directing marketing personnel to communicate with customers/subscribers associated with endpoint devices 111-113 and 121-123 (e.g., those in the areas that may have higher priority on the list (e.g., above a threshold precedence metric and/or above a threshold position in the list, etc.)). In one example, the instructions may include a map of the geographic area(s) identified in accordance with examples of the present disclosure and/or a listing of customers/subscribers/users segregated by geographic area. In one example, the instructions may include differentiated communications for customers/subscribers of different geographic areas.

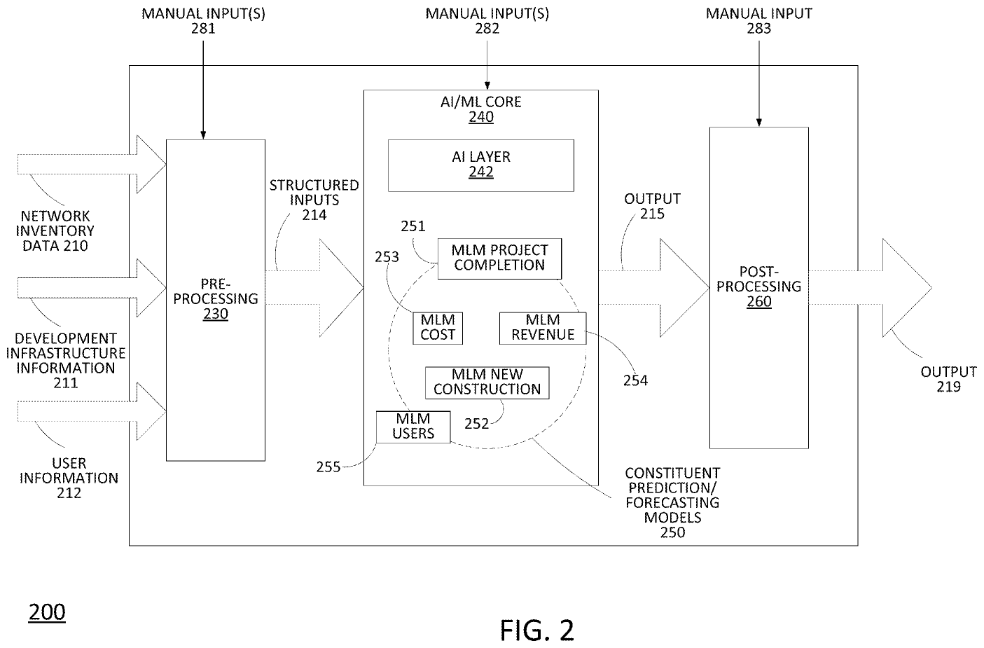

These and other example operations for performing at least one network reconfiguration action in a communication network in accordance with a precedence metric for a new fiber optic data service for a geographic area that is generated via a prediction model based upon current network inventory data, development infrastructure information, and user information are described in greater detail below in connection with the examples of FIGS. 2-4. In addition, it should be realized that the network 100 may be implemented in a different form than that illustrated in FIG. 1, or may be expanded by including additional endpoint devices, access networks, network elements, application servers, etc. without altering the scope of the present disclosure.

FIG. 2 illustrates an example artificial intelligence (AI)/machine learning (ML) platform 200 (e.g., implemented via a processing system including at least one processor) for providing predictions/prioritizations for new fiber optic data services in various geographic areas. In one example, the AI/ML platform 200 may include an AI/ML core 240 comprising an Al layer 242 and a plurality of constituent prediction/forecasting models 250, such as an MLM 251 for forecasting new current fiber optic data service deployment project completions, an MLM 252 for forecasting completion of new construction projects, an MLM 253 for forecasting a cost of new fiber optic data service deployment in a geographic area, an MLM 254 for forecasting expected revenue from a new fiber optic data service deployment in a geographic area, an MLM 255 for forecasting new user demand for the new fiber optic data service in the plurality of geographic areas, and so forth.

The AI/ML platform 200 may utilize network inventory data 210, development infrastructure information 211, and user information 212 as inputs (e.g., for both training and prediction). In one example, the input data may be ingested via a pre-processing module 230. For instance, the pre-processing module 230 may include extract, transform, and load (ETL) operations, data cleaning and/or sanitizing operations, aggregation, averaging, smoothing, anonymization, and so forth. In one example, data may be scaled based upon a distance from a subject geographic area. For instance, for a subject geographic area under evaluation, relevant input data for the AI/ML core 240 may include information on network inventory in nearby (e.g., adjacent or otherwise close) geographic areas, information on development infrastructure in nearby geographic areas, user demand in nearby geographic areas, etc. However, the relevance of such data may be considered to have diminishing relevance the further from the subject geographic area. Thus, in one example, input data of this nature may be scaled or weighted, or a combined metric of user demand in an area, for example, may be impacted by the data of nearby geographic areas.

In one example, the pre-processing phase 230 may also be guided by manual input(s) 281. For instance, manual input(s) 281 may include indications of particular geographic areas that are deemed of particular importance or which network personnel would like to provide enhanced priority (e.g., beyond what the other inputs 210-212 would indicate). Alternatively, or in addition, manual input(s) 281 may include feature engineering parameters, e.g., which may indicate how ETL and/or other pre-processing aspects may be implemented (e.g., using daily moving averages versus 48 hour moving averages, setting minimum geographic area size, setting a parameter to permit flexible geographic area size or to use fixed geographic area sizes, etc.). The pre-processing module 230 may thus generate structured inputs 214 as outputs of the pre-processing module 230 (e.g., input data that has been cleansed, sanitized, aggregated, anonymized, etc. and that is otherwise formatted into expected format(s) for the AI/ML core 240).

The AI/ML core 240 may include a plurality of constituent prediction/forecasting models 250, such as an MLM 251 for forecasting new current fiber optic data service deployment project completions, an MLM 252 for forecasting completion of new construction projects an MLM 253 for forecasting a cost of new fiber optic data service deployment in a geographic area, an MLM 254 for forecasting expected revenue from a new fiber optic data service deployment in a geographic area, and so forth. In the present example, constituent prediction/forecasting models 250 may include an MLM 255 for forecasting new user demand for the new fiber optic data service in the plurality of geographic areas. For instance, the output of such an MLM/forecasting model may comprise a number of users expected to ask for the new service or the expected number of users to be served if the new service is deployed, or there may be two MLMs for each of these respective forecast metrics.

In accordance with the present disclosure, the constituent prediction/forecasting models 250 may each comprise a trained machine learning algorithm. For instance, a machine learning algorithm (MLA), or machine learning model (MLM) trained via a MLA may comprise: a deep learning neural network, or deep neural network (DNN), a recurrent neural network (RNN), a long-short term memory (LSTM) neural network, a convolutional neural network (CNN), a generative adversarial network (GAN), a decision tree algorithms/models, such as gradient boosted decision tree (GBDT) (e.g., XGBoost, or the like), a support vector machine (SVM), e.g., a binary, non-binary, or multi-class classifier, a linear or non-linear classifier, and so forth. In one example, the MLA may incorporate an exponential smoothing algorithm (such as double exponential smoothing, triple exponential smoothing, e.g., Holt-Winters smoothing, and so forth), reinforcement learning (e.g., using positive and negative examples after deployment as a MLM), and so forth. It should be noted that various other types of MLAs and/or MLMs may be implemented in examples of the present disclosure, such as k-means clustering and/or k-nearest neighbor (KNN) predictive models, support vector machine (SVM)-based classifiers, e.g., a binary classifier and/or a linear binary classifier, a multi-class classifier, a kernel-based SVM, etc., a distance-based classifier, e.g., a Euclidean distance-based classifier, or the like, and so on. For instance, a distance from a separation hyperplane of a binary classifier may be scaled to: a forecast cost, a forecast revenue, a forecast number of users, a forecast time to completion and/or a forecast of a likelihood of an on-time completion of a development infrastructure project or a network inventory deployment project, and so forth.

In one example, the constituent prediction/forecasting models 250 may include one or more time series prediction/forecasting models, such as a moving average (MA) model, an autoregressive distributed lag (ADL) model, an autoregressive integrated moving average (ARIMA) model, a seasonal ARIMA (SARIMA) model, or the like. Similarly, other regression-based models may be trained and used for prediction/forecasting of the present disclosure, such as logistic regression, polynomial regression, ridge regression, lasso regression, etc. In one example, the present disclosure may predict/forecast user demand, population density, building density/coverage, network inventory availability, etc. using multiple factors as predictors (e.g., covariates, or exogenous factors). For instance, a seasonal auto-regressive integrated moving average with exogenous factors (SARIMAX) model may be used. Alternatively, a vector auto-regression (VAR), or VAR moving average (VARMA) model may be used. Similarly, a vector auto-regression moving-average with exogenous factors/regressors (VARMAX) model may be applied. In one example, an output between 0 and 1 may indicate a probability (e.g., a likelihood) of development project completion at a future time period, may indicate a likelihood of “high user demand” versus “low user demand” at a future time period, and so forth.

In one example, different MLMs may be used for different types of forecasting in accordance with the present disclosure. Thus, for instance, each of the constituent prediction/forecasting models 250 may be of a different type. In one example, the AI/ML platform 200 may implement a training/development phase in which different MLMs may be evaluated/benchmarked for performance, and the top performing MLMs may be selected for use in the respective forecasting/prediction tasks. In one example, the structured inputs 214 may be used for training/testing and for development of the constituent prediction/forecasting models 250. For instance, each of the constituent prediction/forecasting models 250 may be trained/optimized for accuracy, speed, and/or combination of such criteria. To illustrate, MLM 251 may be trained to forecast project completion times of current/ongoing and/or scheduled network inventory deployment based upon all or a portion of the structured inputs 214. In one example, the AI/ML platform 200 may continue to monitor the network inventory deployment for actual completion time, which may then be compared to the prior forecast project completion time. The difference between the forecast/predicted and actual completion times may then be taken as a loss metric, where the training of MLM 251 may continue to minimize the loss metric and/or continue until the loss metric is below a threshold. In other words, the MLM 251 may be considered to have achieved a target/threshold accuracy. Likewise, MLM 254 may be trained to predict/forecast revenue of a new network inventory deployment six (6) months into the future. Thus, when the six months have passed, the AI/ML platform 200 may obtain feedback data on the actual revenues associated with the new network inventory deployment. Any discrepancy between the forecast/predicted and the actual 6 month revenue may then be taken as a loss metric, where the training of MLM 254 may continue to minimize the loss metric and/or continue until the loss metric is below a threshold. A similar training process may be applied to the other ones of the constituent prediction/forecasting models 250. Alternatively, or in addition, historic network inventory data 210, development infrastructure information 211, and user information 212 may already include data that may be used as “labels” for training/testing. For instance, MLM 254 may be trained to predict/forecast a revenue from a new fiber infrastructure after 6 months of deployment. In this case, data from 2.5 years prior to the present time regarding existing deployments may be available for use as inputs/predictors, where data on the actual revenues from 2 years prior to the present time (which is 6 months after the input/predictor data) is also available as part of the historic network inventory data 210.

In one example, the at least one precedence metric is based on an objective function with variables of: a forecast revenue for the new fiber optic service in a given geographic area (e.g., from MLM 254) and a forecast cost of deployment in the given geographic area (e.g., from MLM 253). In one example, the objective function may further include at least one additional variable for a forecast number of users to be served in the given geographic area (e.g., from MLM 255). In various other examples, the at least one precedence metric may be based upon a forecast of new development/building construction (e.g., from MLM 252), and so forth. In one example, the objective function may be implemented via Al layer 242. In one example, the at least one precedence metric may be based upon a weighted combination of the above variables. In one example, the weights may be adjusted based upon various preferences of a communication network operator. Alternatively, or in addition, the Al layer 242 may comprise an additional MLM that is trained based upon labeled data/feedback regarding the precedence metrics output from the AI/ML core 240. For instance, network personnel may review the output 215 and may identify instances where the network personnel agree with the rankings/precedence metrics for various geographic areas being evaluated, and conversely where network personnel disagree with the rankings/precedence metrics for various geographic areas being evaluated. It should be noted that once trained, the AI/ML core 240 may continue to process new/current input data (e.g., network inventory data 210, development infrastructure information 211, user information 212, etc.). In the present example, the output 215 may comprise a precedence metric for a subject geographic area being evaluated. However, it should be noted that the same or similar process may be applied with respect to a plurality of candidate/subject geographic areas, where respective precedence metrics may be included in output 215 for each such geographic area. In one example, AI/ML core 240 may be configured in accordance with manual input(s) 282. For instance, manual input(s) 282 may specify various hyperparameters of the constituent prediction/forecasting models 250, such as a number of fully-connected layers, a target accuracy, etc., weights to apply to different variables for one or more rule-based elements of Al layer 242, and so forth.

In one example, the AI/ML core 240 may be further configured to generate a recommended deployment type for the new fiber optic data service in the geographic areas of the plurality of geographic areas that do not include a current fiber optic data service of the communication network, such as fiber to the premises (FTTP), fiber to the curb (FTTC), fixed wireless broadband (FWB)/fiber hybrid, leased fiber access, etc. To further illustrate, the recommended deployment type may be selected based upon at least one of: respective projected costs associated with plurality of deployment types for a given geographic area or respective projected revenues associated with the plurality of deployment types for the given geographic area (e.g., from the one or more MLMs as discussed above). For instance, in one example, the Al layer 242 may further include one or more rule-based elements for determining the type of deployment, e.g., selecting among FTTP, FTTC, FWB/fiber hybrid, or leased fiber access. To illustrate, a rule-based processing may be as follows: (1) identify whether there is an open access provider that is already providing fiber to a given geographic area, (2) if yes, then identify how the fiber is built and also identify whether an existing fiber access provider is willing to lease fiber access, (3) determine cost of leasing fiber, (4) if fiber is dark fiber determine cost to light the fiber, (5) if fiber is lit, identify what it would cost to bring communication network fiber service into the premises, (6) compare cost to lease to estimated cost to build, and (7) select between lease versus build based on cost comparison. Additional rules-based elements of a same or similar nature may be implemented via Al layer 242 with respect to when there is not an open access provider available, when the utility type is overhead versus buried, and so forth.

In the present example, AI/ML platform 200 may further include a post-processing module 260. For instance, the post-processing module 260 may include the application of anonymization and encryption, etc. In one example, the post-processing module 260 may apply further operations based upon manual input(s) 283, such as a network operator preference for one or more types of network reconfiguration actions to be implemented. For instance, input(s) 283 may specify that a ranked list of prioritized geographic areas should be provided to network personnel A, B, and C, which may be represented by output 219. Alternatively, or in addition, input(s) 283 may specify that output 219 should comprise a map of prioritized geographic areas. For instance, geographic areas having the top 10 percent of precedence metrics may be shaded green on such a map, geographic areas having the top 65^{th} to 90^{th} percentiles in the list may be shaded blue on such a map, and geographic areas below the 65^{th} percentile may be shaded red on such map, and so forth. In one example, manual input(s) 283 may include a preference that outputs 219 comprise instructions to a marketing automation platform to send automated marketing communications to one or more subscribers/customers/users, to place geographically relevant advertisements on one or more websites and/or via one or more applications (apps) directed to users identified as being within or otherwise associated with geographic areas having top precedence metrics, and so forth.

It should be noted that FIG. 2 illustrates just one example architecture of an AI/ML platform 200 and that other, further, and different examples may have a different set of constituent prediction/forecasting models 250 or other architecture. In one example, the expected cost may be accounted for as part of the forecast revenue of MLM 254 (e.g., forecast revenue after expenses, forecast revenue after expenses amortized over a period of time), etc. In other words, the MLM 253 for forecast costs may be omitted. Alternatively, or in addition, the output forecast costs of MLM 253 may comprise an input/predictor of the MLM 254 for forecasting expected revenue. In one example, there may be multiple models for forecasting expected revenue at various future time periods, e.g., 3 months, 6 months, one year, two years, five years, etc. It should be noted that, expected revenue can be based upon the number of users in the user information 212, new construction or existing construction data from the development infrastructure information 211, etc. In another example, one or more of the constituent prediction/forecasting models 250 may comprise an AI model (e.g., one that is not necessarily ML-based). In one example, one or more of the constituent prediction/forecasting models 250 may be omitted and a comprehensive MLM for generating a precedence metric may be used. For instance, the MLM may be trained in accordance with an objective metric to minimize a number of instances of network personnel indicating that a geographic area's precedence metric is inaccurate, disagreed with, or the like. Thus, these and other modification are all contemplated within the scope of the present disclosure.

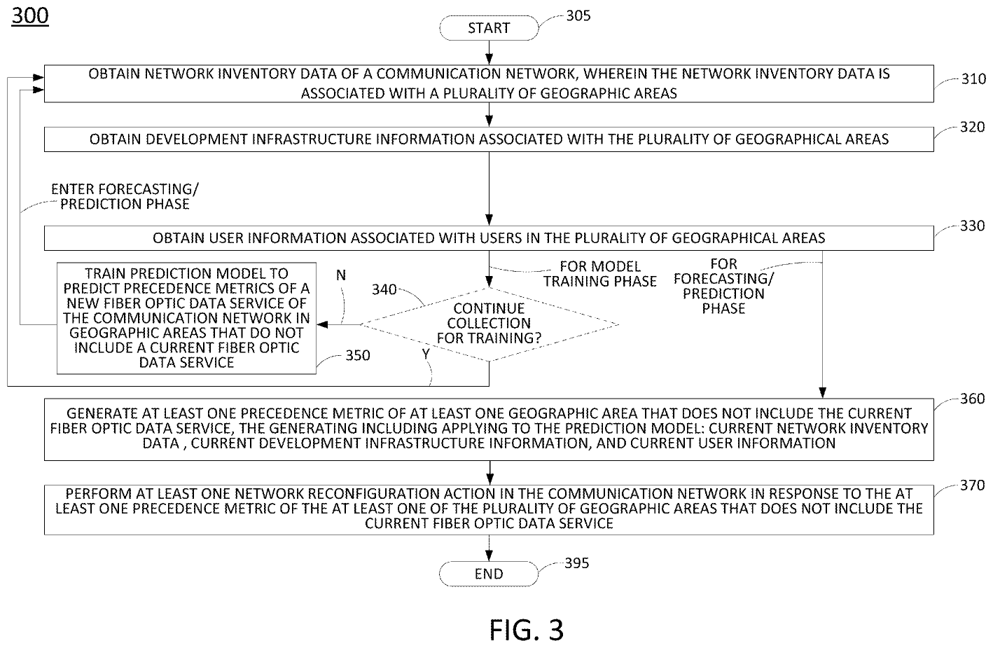

FIG. 3 illustrates a flowchart of an example method 300 for performing at least one network reconfiguration action in a communication network in accordance with a precedence metric for a new fiber optic data service for a geographic area that is generated via a prediction model based upon current network inventory data, development infrastructure information, and user information. In one example, the steps, operations, or functions of the method 300 may be performed by any one or more of the components of the system 100 depicted in FIG. 1. For instance, in one example, the method 300 may be performed by the server(s) 135, or by server(s) 135 in conjunction with other components of the system 100, and/or any one or more components thereof (e.g., a processor, or processors, performing operations stored in and loaded from a memory), or by one or more of server(s) 135 in conjunction with one another and/or one or more other devices or systems, such as server(s) 136, one or more external/3^{rd} party data sources, and so forth. In one example, the steps, functions, or operations of method 300 may be performed by a computing device or system 400, and/or processor 402 as described in connection with FIG. 4 below. For instance, the computing device or system 400 may represent any one or more components of server(s) 135, etc. in FIG. 1 that is/are configured to perform the steps, functions and/or operations of the method 300. Similarly, in one example, the steps, functions, or operations of method 300 may be performed by a processing system comprising one or more computing devices collectively configured to perform various steps, functions, and/or operations of the method 300. For instance, multiple instances of the computing device or processing system 400 may collectively function as a processing system. For illustrative purposes, the method 300 is described in greater detail below in connection with an example performed by a processing system.

The method 300 begins at step 305 and proceeds to step 310. In step 310, the processing system obtains network inventory data of a communication network, where the network inventory data is associated with a plurality of geographic areas. For instance, the network inventory data may be obtained from a network inventory database (e.g., an AAI database or the like), and may include existing network inventory data, current network inventory deployment projects in the communication network, and/or scheduled network inventory deployment projects in the communication network. For instance, the network inventory data may include data on the types of access network technology, e.g., fiber, cable, DSL, etc., the components thereof (e.g., DSLAM make, model, etc. fiber mode, fiber capacity, etc., and so forth), the utilization levels of such resources, the installation dates, the useful life, the scheduled replacement date(s) (if any), and so forth. In one example, the network inventory data may include a central office (CO) proximity metric and/or a proximity of fiber build in adjacent or nearby areas. For instance, geographic areas adjacent to areas that already have fiber deployed may have greater priority than isolated pockets of demand that are not near any other existing fiber. In one example, the geographic areas may be regions that are already defined for other purposes in the communication network, e.g., distribution areas (DAs) or the like. However, in another example, the geographic areas may be defined by a number of users, development density, road infrastructure coverage, terrain type, etc., and/or combination of these factors.

In step 320, the processing system obtains development infrastructure information associated with the plurality of geographic areas. For instance, the development infrastructure information may include information associated with existing buildings in the plurality of geographic areas, information associated with current building construction projects in the plurality of geographic areas, and/or information associated with scheduled building construction projects in the plurality of geographic areas. In one example, the development infrastructure information may include other infrastructure and user-related information such as the morphology, e.g., urban, suburban, rural. Alternatively, or in addition, the development infrastructure information may also include factors for ease of infrastructure development (which may be included in a database of such information by network personnel or obtained from other data sources, such as trade industry data that may be published via an API or the like). In one example, the development infrastructure information may include utility type information (e.g., a buried utilities type or an overhead utilities type). In addition, the utility type information may be for existing, current in development, and scheduled development infrastructure. For instance, the effect on the precedence metric, the effect on the forecast cost of deployment and/or forecast expected revenue, or the like that may be generated at step 360 can be different depending on the utility type information. For instance, for a scheduled buried utility project, the cost to add fiber may be considered as minimal. However, for existing buried utility services, the cost can be very high because access may require digging. Existing overhead wiring can be associated with reduced upfront costs, but the projected earnings may be lower to account for a slightly higher risk of outages, and so on.

In step 330, the processing system obtains user information associated with users in the plurality of geographic areas (e.g., current users and/or prospective users). For instance, the user information may include demographic information of the plurality of geographic areas, information associated with current users of the communication network who do not have the current fiber optic data service, and/or information associated with users requesting the new fiber optic data service. To further illustrate, the user information may relate to population density in addition to current users and prospective users. In one example, the user information may be particularized to include types of users, e.g., residential, commercial/business, governmental, or other user types.

In optional step 340, the processing system may determine whether to continue to collect data for training at least one prediction model for predicting precedence metrics of a new fiber optic data service of the communication network in geographic areas of the plurality of geographic areas that do not include a current fiber optic data service of the communication network. If answered in the affirmative, the method 300 may return to step 310. For instance, the processing system may continue to collect any or all of such types of data for a defined period of time and/or until a threshold quantity of data is collected. If answered in the negative, the method 300 may proceed to step 350 (e.g., the threshold duration of time and/or quantity of data may be collected after a number of repetitions of any or all of steps 310-330).

At step 350, the processing system may train (or retrain) a prediction model, e.g., as described above, to forecast/predict network in geographic areas of the plurality of geographic areas that do not include a current fiber optic data service of the communication network based upon one or more input factors such as: network inventory data of the communication network, the network inventory data is associated with a plurality of geographic areas, development infrastructure information associated with the plurality of geographic areas, and user information associated with users in the plurality of geographic areas. As noted above, the prediction model may include at least one machine learning model (MLM). For instance, the at least one MLM may include one or more of: a forecasting model for forecasting completion of new network inventory deployment projects in the communication network, a forecasting model for forecasting new building construction projects in the plurality of geographic areas, a forecasting model for forecasting new user demand for the new fiber optic data service in the plurality of geographic areas, a forecasting model for forecasting a cost of deployment of the new fiber optic data service in the plurality of geographic areas, a forecasting model for forecasting an expected revenue of the new fiber optic data service in the plurality of geographic areas, and so forth. For example, any or all of these forecasting models may comprise a DNN, a GAN, a decision tree algorithm/model, such as a GBDT or the like, and so forth. In another example, the at least MLM may comprise a distance-based binary classifier, which may determine a distance of an input vector from a separation hyperplane that comprises or corresponds to a forecast number of users, a forecast time to complete a development project, a forecast time to complete a network inventory deployment, etc. In one example, the at least one MLM may alternatively or additionally comprise a time series prediction model that may predict/forecast a user demand future time period, a population density at a future time period, a building coverage or density at a future time period, etc.

It should be noted that at least some of the historic data may be used as labels for the training. For instance, the at least one forecasting model may be trained by: making predictions for later time periods based upon preceding data, and identifying the accuracy of such predictions based upon the actual measured/obtained data from the time period for which the forecast/prediction is made. In one example, step 350 may include training multiple MLMs for a same sub-task (e.g., forecasting cost, forecasting revenue, forecasting project completion, etc.), identifying a best performing MLM and selecting such MLM for use with respect to a given sub-task. It should again be noted that the foregoing is provided by way of illustration only, and that in other, further, and different examples, more or less MLMs may be used, a different set of one or more MLMs may be used, and so forth. For instance, in another example, the expected cost may be accounted for as part of the forecast revenue (e.g., forecast revenue after expenses, forecast revenue after expenses amortized over a period of time), etc. Similarly, as noted above, there may be multiple models for forecasting expected revenue at various future time periods, e.g., 3 months, 6 months, one year, two years, five years, etc. For instance, the expected revenue may be based upon the number of users in the user information, the new construction or existing infrastructure information, etc.

In one example, the prediction model may be further trained to generate a recommended deployment type for the new fiber optic data service in the geographic areas of the plurality of geographic areas that do not include a current fiber optic data service of the communication network. For instance, the recommended deployment type may comprise a selected one of a plurality of deployment types including two or more of: a fiber to the premises (FTTP) deployment type, a fiber to the curb (FTTC) deployment type, or a fixed wireless broadband (FWB)/fiber hybrid deployment type, a leased fiber access deployment type, etc. To further illustrate, the recommended deployment type may be selected based upon at least one of: respective projected costs associated with plurality of deployment types for a given geographic area or respective projected revenues associated with the plurality of deployment types for the given geographic area (e.g., from the one or more MLMs as discussed above). In one example, the prediction model may further include an Al layer, e.g., one or more rule-based elements for generating a precedence metric based on the outputs of one or more MLMs and/or the outputs of one or more MLMs in conjunction with any or all data of steps 310-330. In one example, the Al layer may include one or more rules for determining the type of deployment, e.g., selecting among FTTP, FTTC, FWB/fiber hybrid, or leased fiber access. To illustrate, a rule-based processing may be as follows: (1) identify whether there is an open access provider that is already providing fiber to a given geographic area, (2) if yes, then identify how the fiber is built and also identify whether an existing fiber access provider is willing to lease fiber, (3) determine cost of leasing fiber, (4) if fiber is dark fiber determine cost to light the fiber, (5) if fiber is lit, identify what it would cost to bring communication network fiber service into the premises, (6) compare cost to lease to estimated cost to build, and (7) select between lease versus build based on cost comparison.

Following optional step 350, the method 300 may enter a forecasting/prediction phase and may return to step 310. Thus, for example, a repetition of any or all of steps 310-330 may be for gathering data relevant to generating a present precedence metric for a subject geographic area. In one example, data may be gathered and stored over successive time periods, e.g., such that the processing system possesses historical to current network inventory data, development infrastructure information, user information, and so forth. To further illustrate, the processing system may collect current network inventory data of the communication network associated with the plurality of geographic areas, current development infrastructure information associated with the plurality of geographic areas, and current user information associated with the users in the plurality of geographic areas. For instance, the current network inventory data of the communication network associated with the plurality of geographic areas may comprise a most recent available network inventory data associated with the plurality of geographic areas. In addition, the current development infrastructure information associated with the plurality of geographic areas may comprise a most recent available development infrastructure information associated with the plurality of geographic areas. Similarly, the current user information associated with the users in the plurality of geographic areas may comprise a most recent information associated with users in the at least one geographic areas. In other words, this does not mean just the last network inventory data, but can include a time series of network inventory data (e.g., percent coverage can indicate how deployment project(s) has/have progressed). Similarly, the current user data may not just involve user requests for new fiber optic service that have been received in the last month, but could include all unfulfilled requests from the last year. In one example, the processing system may apply a time weighting to the requests such that older unfulfilled requests may have less weight (or more weight), etc.

In step 360, the processing system generates at least one precedence metric of at least one of the plurality of geographic areas that does not include the current fiber optic data service. For instance, step 360 may comprise applying to the prediction model: the current network inventory data of the communication network associated with the at least one geographic areas, the current development infrastructure information associated with the at least one geographic area, and the current user information associated with users in the at least one geographic areas. As noted above, an output of the prediction model may comprise the at least one precedence metric. As also noted above, the prediction model may comprise at least one of the MLMs. Thus, in one example, step 360 may comprise applying at least a portion of the current network inventory data, development infrastructure information, and user information to one or more of the MLMs. In one example, an output of one or more of the MLMs may comprise inputs/predictors to one or more of the other MLMs. Thus, in one example, step 360 may include applying various data to the one or more MLMs in a pipeline, e.g., in a defined order (where both sequential and parallel processing may be applied depending upon the particular configuration of MLMs).

In one example, the at least one precedence metric may be based on an objective function with variables of: a forecast revenue for the new fiber optic service in a given geographic area and a forecast cost of deployment in the given geographic area. In one example, such an objective function may further include at least one additional variable for a forecast number of users to be served in the given geographic area, such as a forecast number of users in 3 months, 6 months, 2 years, etc. For instance, there may be new construction where there is easy access to a utility right of way, but the forecast number of users may be low in the first 9 months for which the forecast is made. However, within 2 years, the forecast number of users to be served may be much higher when the residential or commercial construction is anticipated to conclude and when low vacancy is anticipated. Such an objective function may have one or more other variables in various examples, such as an environmental impact factor, a manual weighting factor (e.g., to raise or lower the priority of the given geographic area), etc.

In step 370, the processing system performs at least one network reconfiguration action in the communication network in response to the at least one precedence metric of the at least one of the plurality of geographic areas that does not include the current fiber optic data service. For instance, in one example, step 370 may include reporting the at least one precedence metric to one or more designated devices, systems, and/or users (e.g., network personnel). In one example, the at least one network reconfiguration action may include generating a list of prioritized geographic areas for new fiber optic data service deployment. In one example, the list may further include recommended deployment types in accordance with the output(s) of the prediction model, such as FTTP, FTTC, FWB/fiber hybrid, leased fiber access, etc. In one example, the at least one network reconfiguration action may include generating and/or transmitting a map of prioritized geographic areas for the new fiber optic service deployment. In one example, the at least one network reconfiguration action may include sending instructions to a marketing automation platform to send automated marketing communications to one or more of endpoint devices and/or users associated with higher priority geographic areas. In one example, the at least one network reconfiguration action may include automatically reconfiguring one or more network elements to provide the new fiber optic data service, e.g., via activation of service over 3^{rd} party existing fiber. In one example, step 370 may further include obtaining an indication of fiber deployment and actual user orders, and automatically activating a service over the new deployed fiber. Additional network reconfiguration actions are discussed in greater detail above, such as initiating one or more surveys, questionnaires, or the like, sending instructions to marketing personnel endpoint device to communicate with customers/subscribers (e.g., those in areas that may have high priority on the list), and so on. Following step 370, the method 300 proceeds to step 395 where the method 300 ends.

It should be noted that the method 300 may be expanded to include additional steps, or may be modified to replace steps with different steps, to combine steps, to omit steps, to perform steps in a different order, and so forth. For instance, in one example the processing system may repeat one or more steps of the method 300, such as steps 310-370, and so forth. For instance, the method 300 may continue to be performed, in whole or in part, on an ongoing basis. In this regard, it should be noted that in one example, the method 300 may continue to gather new data to generate new precedence metrics, e.g., to obtain new prioritized lists of geographic areas, etc. on an ongoing basis (e.g., monthly, bi-monthly, etc.) and may return to a training phase to retrain the prediction model and/or one or more constituent MLMs thereof (or to train one or more new prediction models). In one example, the method 300 may further include obtaining manual input(s) which may indicate higher or lower priority for various geographic areas and/or indications of higher or lower likelihood of new construction/development, higher or lower use demand, or the like. In one example, the method 300 may further include gathering feedback/labels, identifying when a threshold of time and/or a threshold quantity of feedback/labels is gathered, and retraining based on the available feedback/labels. In one example, the method 300 may further include performing a geographic clustering process to identify the geographic areas to be evaluated via the method 300. For instance, geographic areas may be bounded based upon a number of users, development density, and/or combination of these factors. Alternatively, or in addition, geographic area identification may also account for road infrastructure coverage, terrain type, and so forth. In one example, geographic clustering may be according to an algorithm or formula. In one example, the method 300 may be expanded or modified to include steps, functions, and/or operations, or other features described above in connection with the example(s) of FIGS. 1 and 2, or as described elsewhere herein. Thus, these and other modifications are all contemplated within the scope of the present disclosure.

In addition, although not expressly specified above, one or more steps of the method 300 may include a storing, displaying and/or outputting step as required for a particular application. In other words, any data, records, fields, and/or intermediate results discussed in the method can be stored, displayed and/or outputted to another device as required for a particular application. Furthermore, operations, steps, or blocks in FIG. 3 that recite a determining operation or involve a decision do not necessarily require that both branches of the determining operation be practiced. In other words, one of the branches of the determining operation can be deemed as an optional step. However, the use of the term “optional step” is intended to only reflect different variations of a particular illustrative embodiment and is not intended to indicate that steps not labelled as optional steps to be deemed to be essential steps. Furthermore, operations, steps or blocks of the above described method(s) can be combined, separated, and/or performed in a different order from that described above, without departing from the example embodiments of the present disclosure.

FIG. 4 depicts a high-level block diagram of a computing device or processing system specifically programmed to perform the functions described herein. For example, any one or more components or devices illustrated in FIG. 1 or described in connection with the examples of FIGS. 2 and 3 may be implemented as the processing system 400. As depicted in FIG. 4, the processing system 400 comprises one or more hardware processor elements 402 (e.g., a microprocessor, a central processing unit (CPU) and the like), a memory 404, (e.g., random access memory (RAM), read only memory (ROM), a disk drive, an optical drive, a magnetic drive, and/or a Universal Serial Bus (USB) drive), a module 405 for performing at least one network reconfiguration action in a communication network in accordance with a precedence metric for a new fiber optic data service for a geographic area that is generated via a prediction model based upon current network inventory data, development infrastructure information, and user information, and various input/output devices 406, e.g., a camera, a video camera, storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like).

Although only one processor element is shown, it should be noted that the computing device may employ a plurality of processor elements. Furthermore, although only one computing device is shown in the Figure, if the method(s) as discussed above is implemented in a distributed or parallel manner for a particular illustrative example, i.e., the steps of the above method(s) or the entire method(s) are implemented across multiple or parallel computing devices, e.g., a processing system, then the computing device of this Figure is intended to represent each of those multiple computing devices. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented. The hardware processor 402 can also be configured or programmed to cause other devices to perform one or more operations as discussed above. In other words, the hardware processor 402 may serve the function of a central controller directing other devices to perform the one or more operations as discussed above.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computing device, or any other hardware equivalents, e.g., computer readable instructions pertaining to the method(s) discussed above can be used to configure a hardware processor to perform the steps, functions and/or operations of the above disclosed method(s). In one example, instructions and data for the present module or process 405 for performing at least one network reconfiguration action in a communication network in accordance with a precedence metric for a new fiber optic data service for a geographic area that is generated via a prediction model based upon current network inventory data, development infrastructure information, and user information (e.g., a software program comprising computer-executable instructions) can be loaded into memory 404 and executed by hardware processor element 402 to implement the steps, functions or operations as discussed above in connection with the example methods 200 and 300. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 405 for performing at least one network reconfiguration action in a communication network in accordance with a precedence metric for a new fiber optic data service for a geographic area that is generated via a prediction model based upon current network inventory data, development infrastructure information, and user information (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. Furthermore, a “tangible” computer-readable storage device or medium comprises a physical device, a hardware device, or a device that is discernible by the touch. More specifically, the computer-readable storage device may comprise any physical devices that provide the ability to store information such as data and/or instructions to be accessed by a processor or a computing device such as a computer or an application server.

While various examples have been described above, it should be understood that they have been presented by way of example only, and not limitation. Thus, the breadth and scope of a preferred example should not be limited by any of the above-described examples, but should be defined only in accordance with the following claims and their equivalents.

What is claimed is:

1. A method comprising:
obtaining, by a processing system including at least one processor, network inventory data of a communication network, wherein the network inventory data is associated with a plurality of geographic areas;
obtaining, by the processing system, development infrastructure information associated with the plurality of geographic areas;
obtaining, by the processing system, user information associated with users in the plurality of geographic areas;
training, by the processing system, a prediction model to predict precedence metrics of a new fiber optic data service of the communication network in geographic areas of the plurality of geographic areas that do not include a current fiber optic data service of the communication network, wherein the prediction model comprises at least one machine learning model;
generating, by the processing system, at least one precedence metric of at least one of the plurality of geographic areas that does not include the current fiber optic data service, wherein the generating comprises applying to the prediction model: current network inventory data of the communication network associated with the plurality of geographic areas, current development infrastructure information associated with the plurality of geographic areas, and current user information associated with users in the plurality of geographic areas, wherein an output of the prediction model comprises the at least one precedence metric; and
performing, by the processing system, at least one network reconfiguration action in the communication network in response to the at least one precedence metric of the at least one of the plurality of geographic areas that does not include the current fiber optic data service.

2. The method of claim 1, wherein the network inventory data comprises at least one of:
existing network inventory data;
current network inventory deployment projects in the communication network; or
scheduled network inventory deployment projects in the communication network.

3. The method of claim 1, wherein the development infrastructure information comprises at least one of:
information associated with existing buildings in the plurality of geographic areas;
information associated with current building construction projects in the plurality of geographic areas; or
information associated with scheduled building construction projects in the plurality of geographic areas.

4. The method of claim 1, wherein the user information comprises at least one of:
demographic information of the plurality of geographic areas;
information associated with current users of the communication network who do not have the current fiber optic data service; or
information associated with users requesting the new fiber optic data service.

5. The method of claim 1, wherein the current network inventory data of the communication network associated with the plurality of geographic areas comprises a most recent available network inventory data associated with the plurality of geographic areas, wherein the current development infrastructure information associated with the plurality of geographic areas comprises a most recent available development infrastructure information associated with the plurality of geographic areas, and wherein the current user information associated with the users in the plurality of geographic areas comprises a most recent user information associated with the users in the at least one geographic areas.

6. The method of claim 1, wherein the at least one precedence metric is based on an objective function with variables of: a forecast revenue for the new fiber optic service in a given geographic area and a forecast cost of deployment in the given geographic area.

7. The method of claim 6, wherein the objective function further includes at least one additional variable for a forecast number of users to be served in the given geographic area.

8. The method of claim 1, wherein the at least one machine learning model comprises a forecasting model for forecasting completion of new network inventory deployment projects in the communication network.

9. The method of claim 1, wherein the at least one machine learning model comprises a forecasting model for forecasting new building construction projects in the plurality of geographic areas.

10. The method of claim 1, wherein the at least one machine learning model comprises a forecasting model for forecasting a new user demand for the new fiber optic data service in the plurality of geographic areas.

11. The method of claim 1, wherein the at least one machine learning model comprises a forecasting model for forecasting a cost of deployment of the new fiber optic data service in the plurality of geographic areas.

12. The method of claim 1, wherein the at least one machine learning model comprises a forecasting model for forecasting an expected revenue of the new fiber optic data service in the plurality of geographic areas.

13. The method of claim 1, wherein the network inventory data includes a central office proximity metric.

14. The method of claim 1, wherein the development infrastructure information include a utility type information, wherein the utility type information comprises one of:
a buried utilities type; or
an overhead utilities type.

15. The method of claim 1, wherein the prediction model is further trained to generate a recommended deployment type for the new fiber optic data service in the geographic areas of the plurality of geographic areas that do not include a current fiber optic data service of the communication network.

16. The method of claim 15, wherein the recommended deployment type comprises a selected one of a plurality of deployment types including two or more of:
a fiber to the premises deployment type;
a fiber to the curb deployment type; or
a fixed wireless broadband fiber hybrid deployment type.

17. The method of claim 16, wherein the recommended deployment type is selected based upon at least one of: respective projected costs associated with plurality of deployment types for a given geographic area or respective projected revenues associated with the plurality of deployment types for the given geographic area.

18. The method of claim 15, wherein the network inventory data comprises information associated with existing fiber optic deployments of a third party in the plurality of geographic areas, wherein the recommended deployment type comprises a third party fiber access deployment type.

19. A non-transitory computer-readable medium storing instructions which, when executed by a processing system including at least one processor deployed in a communication network, cause the processing system to perform operations, the operations comprising:
obtaining network inventory data of the communication network, wherein the network inventory data is associated with a plurality of geographic areas;
obtaining development infrastructure information associated with the plurality of geographic areas;
obtaining user information associated with users in the plurality of geographic areas;
training a prediction model to predict precedence metrics of a new fiber optic data service of the communication network in geographic areas of the plurality of geographic areas that do not include a current fiber optic data service of the communication network, wherein the prediction model comprises at least one machine learning model;
generating at least one precedence metric of at least one of the plurality of geographic areas that does not include the current fiber optic data service, wherein the generating comprises applying to the prediction model: current network inventory data of the communication network associated with the plurality of geographic areas, current development infrastructure information associated with the plurality of geographic areas, and current user information associated with users in the plurality of geographic areas, wherein an output of the prediction model comprises the at least one precedence metric; and
performing at least one network reconfiguration action in the communication network in response to the at least one precedence metric of the at least one of the plurality of geographic areas that does not include the current fiber optic data service.

20. An apparatus comprising:
a processing system including at least one processor; and
a computer-readable storage medium storing instructions which, when executed by the processing system when deployed in a communication network, cause the processing system to perform operations, the operations comprising:
obtaining network inventory data of the communication network, wherein the network inventory data is associated with a plurality of geographic areas;
obtaining development infrastructure information associated with the plurality of geographic areas;
obtaining user information associated with users in the plurality of geographic areas;
training a prediction model to predict precedence metrics of a new fiber optic data service of the communication network in geographic areas of the plurality of geographic areas that do not include a current fiber optic data service of the communication network, wherein the prediction model comprises at least one machine learning model;
generating at least one precedence metric of at least one of the plurality of geographic areas that does not include the current fiber optic data service, wherein the generating comprises applying to the prediction model: current network inventory data of the communication network associated with the plurality of geographic areas, current development infrastructure information associated with the plurality of geographic areas, and current user information associated with users in the plurality of geographic areas, wherein an output of the prediction model comprises the at least one precedence metric; and
performing at least one network reconfiguration action in the communication network in response to the at least one precedence metric of the at least one of the plurality of geographic areas that does not include the current fiber optic data service.
